(19) United States
(12) Patent Application Publication
(10) Pub. No.: US 2020/0177531 A1
(43) Pub. Date: Jun. 4, 2020

(54) PHOTO SHARING IN A TRUSTED AUTO-GENERATED NETWORK

(71) Applicant: International Business Machines Corporation, Armonk, NY (US)

(72) Inventors: NAN SONG, SHANGHAI (CN); WEN WEN YANG, SHANGHAI (CN); YIN QIAN, SHANGHAI (CN); XIAO XIA MAO, SHANGHAI (CN); YA QING CHEN, SHANGHAI (CN); YI CHEN ZHANG, SHANGHAI (CN); RUN HUA CHI, SHANGHAI (CN)

(21) Appl. No.: 16/207,358

(22) Filed: Dec. 3, 2018

(51) Int. Cl. H04L 12/58; H04L 29/08

(52) U.S. Cl. CPC H04L 51/10; H04L 67/18

(57) ABSTRACT

A computer-implemented method for sharing photos. A non-limiting example of the computer-implemented method includes identifying, using a processor, an event and potential attendees at the event based on photo metadata and facial recognition and establishing, using the processor, the event and attendees at the event. The method sends, using the processor, a preview photo based on original photo from another attendee at the event to an attendee who is a requestor. The method receives, using the processor, a selection of the preview photo from the requestor and sends, using the processor, the original photo based on the preview photo to the requestor.

### BACKGROUND

The present invention generally relates photo sharing and more specifically, to photo sharing in a trusted auto-generated network.

People take photos about events in which they participate or attend. Often, people like to share these photos with others or receive photos from others who attend or participate in the event. Traditionally, people who share photos regarding an event receive all the photos about the event and select some that they want to keep or share on social media. This is the common means of peer-to-peer photo sharing.

### SUMMARY

Embodiments of the present invention are directed to a computer-implemented method for sharing photos. A non-limiting example of the computer-implemented method includes identifying, using a processor, an event and potential attendees at the event based on photo metadata and facial recognition and establishing, using the processor, the event and attendees at the event. The method sends, using the processor, a preview photo based on an original photo from another attendee at the event to an attendee who is a requestor. The method receives, using the processor, a selection of the preview photo from the requestor and sends, using the processor, the original photo based on the preview photo to the requestor.

Embodiments of the present invention are directed to a system for sharing photos. A non-limiting example of the system includes a memory and a processor communicatively coupled to the memory. The processor is operable to execute instructions stored in the memory. The instructions cause the processor to identify an event and potential attendees at the event based on photo metadata and facial recognition and establish the event and attendees at the event. The instructions cause the processor to send a preview photo based on an original photo from another attendee at the event to an attendee who is a requestor and receive a selection of the preview photo from the requestor. The instructions also cause the processor to send the original photo based on the preview photo to the requestor.

Embodiments of the invention are directed to a computer program product for sharing photos, the computer program product comprising a computer readable storage medium having program instructions embodied therewith. The program instructions are executable by a processor to cause the processor to perform a method. A non-limiting example of the method includes identifying, using a processor, an event and potential attendees at the event based on photo metadata and facial recognition and establishing, using the processor, the event and attendees at the event. The method sends, using the processor, a preview photo based on an original photo from another attendee at the event to an attendee who is a requestor. The method receives, using the processor, a selection of the preview photo from the requestor and sends, using the processor, the original photo based on the preview photo to the requestor.

Additional technical features and benefits are realized through the techniques of the present invention. Embodiments and aspects of the invention are described in detail herein and are considered a part of the claimed subject matter. For a better understanding, refer to the detailed description and to the drawings.

### BRIEF DESCRIPTION OF THE DRAWINGS

The specifics of the exclusive rights described herein are particularly pointed out and distinctly claimed in the claims at the conclusion of the specification. The foregoing and other features and advantages of the embodiments of the invention are apparent from the following detailed description taken in conjunction with the accompanying drawings in which:

FIG. 1 depicts a cloud computing environment according to an embodiment of the present invention;

FIG. 2 depicts abstraction model layers according to an embodiment of the present invention;

FIG. 3 depicts a flowchart of a photo sharing method that builds a trusted network according to embodiments of the invention;

FIG. 4 depicts a flowchart of the event and attendee establishment stage of the method of FIG. 3 according to embodiments of the invention;

FIG. 5 depicts exemplary invitation and network screens of a trusted network according to embodiments of the invention;

FIG. 6 depicts low-resolution photo previews from a trusted network according to embodiments of the invention;

FIG. 7 depicts grouping low-resolution photo previews from a trusted network according to embodiments of the invention;

FIG. 8 depicts a screen and selection gesture to retrieve similar photos from a trusted network according to embodiments of the invention;

FIG. 9 depicts returned low-resolution photo previews from a trusted network according to embodiments of the invention;

FIG. 10 depicts returned low-resolution photo previews following an extended gesture from a trusted network according to embodiments of the invention; and

FIG. 11 depicts details of an exemplary computing system capable of implementing aspects of the invention.

The diagrams depicted herein are illustrative. There can be many variations to the diagram or the operations described therein without departing from the spirit of the invention. For instance, the actions can be performed in a differing order or actions can be added, deleted or modified. Also, the term “coupled” and variations thereof describes having a communications path between two elements and does not imply a direct connection between the elements with no intervening elements/connections between them. All of these variations are considered a part of the specification.

In the accompanying figures and following detailed description of the disclosed embodiments, the various elements illustrated in the figures are provided with two or three digit reference numbers. With minor exceptions, the leftmost digit(s) of each reference number correspond to the figure in which its element is first illustrated.

### DETAILED DESCRIPTION

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Various embodiments of the invention are described herein with reference to the related drawings. Alternative embodiments of the invention can be devised without departing from the scope of this invention. Various connections and positional relationships (e.g., over, below, adjacent, etc.) are set forth between elements in the following description and in the drawings. These connections and/or positional relationships, unless specified otherwise, can be direct or indirect, and the present invention is not intended to be limiting in this respect. Accordingly, a coupling of entities can refer to either a direct or an indirect coupling, and a positional relationship between entities can be a direct or indirect positional relationship. Moreover, the various tasks and process steps described herein can be incorporated into a more comprehensive procedure or process having additional steps or functionality not described in detail herein.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “exemplary” is used herein to mean “serving as an example, instance or illustration.” Any embodiment or design described herein as “exemplary” is not necessarily to be construed as preferred or advantageous over other embodiments or designs. The terms “at least one” and “one or more” may be understood to include any integer number greater than or equal to one, i.e. one, two, three, four, etc. The terms “a plurality” may be understood to include any integer number greater than or equal to two, i.e. two, three, four, five, etc. The term “connection” may include both an indirect “connection” and a direct “connection.”

The terms “about,” “substantially,” “approximately,” and variations thereof, are intended to include the degree of error associated with measurement of the particular quantity based upon the equipment available at the time of filing the application. For example, “about” can include a range of ±8% or 5%, or 2% of a given value.

For the sake of brevity, conventional techniques related to making and using aspects of the invention may or may not be described in detail herein. In particular, various aspects of computing systems and specific computer programs to implement the various technical features described herein are well known. Accordingly, in the interest of brevity, many conventional implementation details are only mentioned briefly herein or are omitted entirely without providing the well-known system and/or process details.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

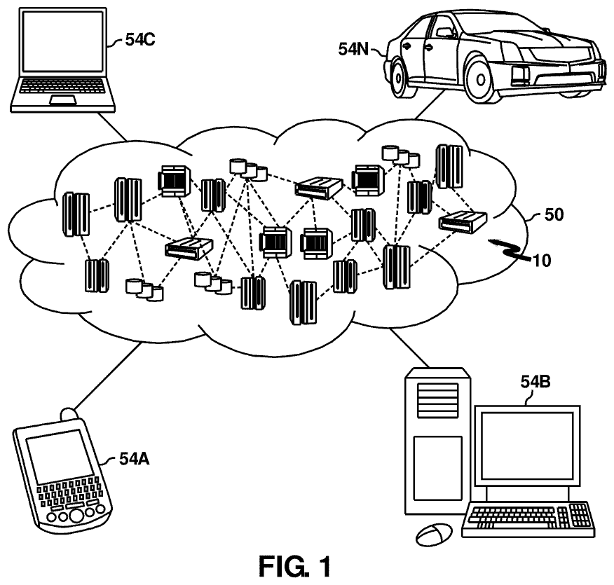

Referring now to FIG. 1, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 1 are intended to be illustrative only and that computing nodes 10 and cloud computing environment 50 can communicate with any type of computerized device over any type of network and/or network addressable connection (e.g., using a web browser).

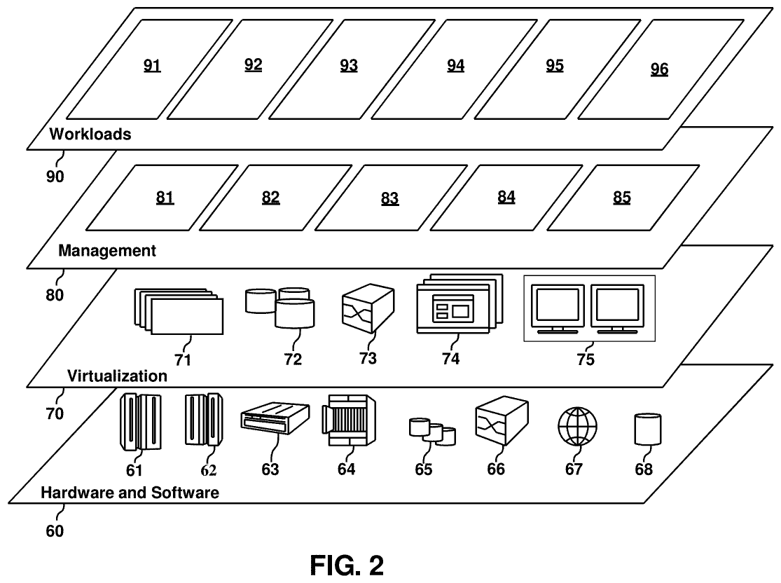

Referring now to FIG. 2, a set of functional abstraction layers provided by cloud computing environment 50 (FIG. 1) is shown. It should be understood in advance that the components, layers, and functions shown in FIG. 2 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and photo sharing processing 96.

Turning now to an overview of technologies that are more specifically relevant to aspects of the invention, traditional photo sharing centers around peer-to-peer sharing of photos of attendees at a shared event. For example, people may attend a party or company event and desire to share photos with each other during or after the event. Unfortunately, there are a host of problems surrounding the sharing of photos in the traditional way. Because the photo owner does not know which photo another attendee, or requestor, would like, the photo owner is most likely to send all of the photos surrounding the event. This is time-consuming and wastes bandwidth and storage space. The photo requestor, without choice, receives all of these photos prior to any form of sorting or filtering. Many unwanted photos will occupy the requestor's device, which poses a burden in terms of storage. In addition, photos featuring one person or scene can be taken by multiple people. This means that transmission needs to happen between several devices during multiple times. This also means that there are duplicate efforts of transferring highly similar photos shot by different people. This is highly inefficient.

Turning now to an overview of the aspects of the invention, one or more embodiments of the invention address the above-described shortcomings of the prior art by providing for automatically establishing an event based on photo metadata and identifying attendees to the event based on facial recognition. Using social media accounts and facial recognition, embodiments of the invention will associate an owner's identity with a device. Once owners of a device are identified, an event is established among parties who are determined to be attendees of the event. To establish the event among parties and attendees, embodiments of the invention use factors that suggest parties proximity to an event, as well as factors that parties are socially connected and involved I the same activity. Parties will be invited to join the event based on establishing the event and the various factors above.

Once this is completed, a trusted network is established which grants access with different levels of granularity to event-associated photos. The granularity is based on the intimacy of people identified in the photos. This allows for multi-level access to photos in another attendee's album based on the auto-created shared event, thus ensuring a high level of security where only photos related to that event are accessible. A preview of the photos on other attendee's devices is shown on a requestor's device. The preview is a smaller data size than the original photo, with key elements of the photo shown in a higher resolution than insignificant elements shown in a lower resolution. The requestor may filter the photos in the preview by a specified interest. The requestor may then request full or partial resolution versions of the original photos from the original device.

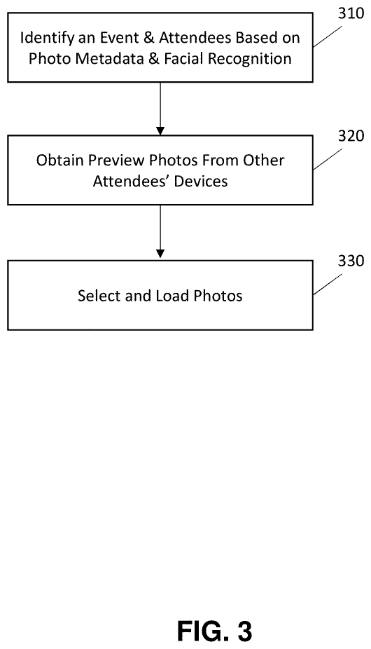

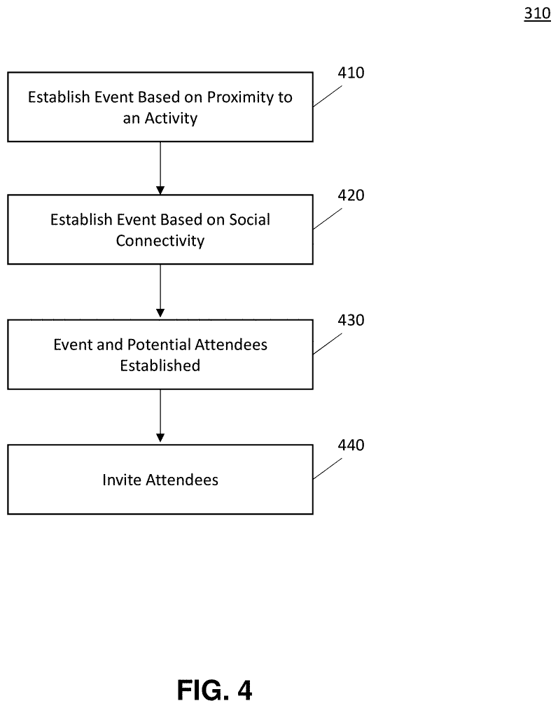

Turning now to a more detailed description of aspects of the present invention, FIG. 3 depicts a flowchart of a photo sharing method that builds a trusted network according to embodiments of the invention. Initially, an event is identified and attendees are identified to form a trusted network. (Stage 310). This will be described in more detail with respect to FIG. 4 in the paragraphs below. Previews of photos from other attendees' devices are provided to an attendee who requests them. (Stage 320). Any device within the trusted network can become a photo requestor. Devices share photos in any of the following ways, for example. A requestor may initiate a gesture, such as a shake gesture, to invoke an action to access and retrieve photos from other devices in the trusted network. Or, photos may be authorized to be shared based on the event and time.

The photos will initially be received as a low resolution preview-mode photo and saved in a buffer. The low resolution preview-mode photos may have a fixed size, for example 500 KB, which is usually much smaller than the original photo size. Key elements of the photo, for example the main subject of the photo, may be shown at a higher resolution, with the background and other unimportant elements shown at a lower resolution or not shown at all. To facilitate selection of photos, photos received by the photo requestor within the trusted network are grouped based on similarity of the photo and the time that the photo was taken. Since photos are gathered from several different sources, it is highly possible that many photos are similar because they contain the same scenery or element, even though they are taken by different people. Thus, it is easier for the photo requestor to select the best photo from similar photos.

The shared photos can be filtered by an element in a photo that is in the photo requester's device. That means, if the requester specifies a filtering element, he or she will receive a set of photos that share the filtering element, ranked by degree of resemblance, from other devices. The element can be specified by selecting an existing photo, touching the interested part of an existing photo, or by entering descriptive keywords (e.g. a baby). The filtered photos, depending on its degree of resemblance to the filtering element, will be shown on the requester's device along a temporal axis, in the format of whirlpool. Photos that resemble the sample photo the most, contain the most matching filtering element, or match the keywords the most, will be shown as the largest and closest to the center. The returned photos are displayed according to their relevance to the input photo, as well as the selected element. Another dimension, such as time, can be used when relevance is at the same level. When a requestor selects to retrieve preview photos based on a requester's photo and a gesture to a part of the photo, the longer a requestor activates the gesture, such as shaking for a longer period of time, the more photos back in time are parsed and returned.

The attendee who requested the previews selects photos from the previews and loads them onto her device. (Stage 330). After the photo requestor gets the preview-mode photos from the other devices stored in her device, she can open the preview-mode photos to examine them. When the requestor is viewing the photos, she can select that photos that she likes, and this action will trigger the system to get the original version of the selected photo, which is stored in the requestor's device. Also, the requested photo may be uploaded directly to the Internet, for example, in a requestor's social media account. Photos not selected for retrieval will be deleted from the buffer during a period of time after non-selection.

FIG. 4 depicts a flowchart of the event and attendee establishment stage of the method of FIG. 3 according to embodiments of the invention. A social event and attendees may be established through factors that suggest people's proximity to an activity. (Stage 410). Every user is recognized via face recognition. Based on the Face ID technology, the user's identity is associated with her device, so the identity of each device in the network is determined. Further, their interrelationships are identified by analyzing the social accounts that are related to a Face ID. In this way, an event is fully established. Only those devices whose photos have similar metadata connected to an activity and have social connections are permitted to this event. In this example, a social event is defined by these details: the date and location when the bunch of photos are shot, the objects in the photos, and the interaction between the devices.

For example, the method may utilize metadata from photos on two devices, for example, the time and location where photos are taken and objects in the photo, to establish two people's proximity to an event based on this metadata being similar. Also, if two people take similar transportation routes to an event that indicate they are going to the same place with an overlapping route, this may be a factor to indicate proximity to an activity. In addition, if two people appear in a group of photos several times, and do not appear to be mere passers-by in the background of the photos, this may also be a factor to suggest proximity to an activity.

A social event and attendees may also be established based on people being socially connected and involved in the same activity. (Stage 420). If socially connected people appear in the same photo at the same place, this may indicate an event and an activity. In another example, if two people have communications records about an activity, such as chat history or emails, this may be a factor that indicates that two people are at an activity.

If two people satisfy a combination of the above factors, they are considered to be attendees of an event. (Stage 430). The above process, stages 410 and 420, are repeated for all persons who may be participating in the activity. Those identified persons are established as potential attendees at an event. Persons identified as attendees may be invited to join a trusted network of attendees at the event if they appear in a number of photos. (Stage 440). Persons who are in only one or two photos are dubious and may be invited to join the trusted network if a member of the trusted network invites them.

The trusted network assigns different granularity levels of access between each different attendee at the event. Higher levels of access are assigned to those attendees who appear to have a greater connection, and lower levels of access are assigned to those attendees who have a lesser connection. Participants' access to different photos varies according to the intimacy between people shown in those photos, based on the analysis of the photo content. For example, if a photo features only A and B, the photo will be accessible to these two people, excluding other participants in the social event. If A and C always appear in a group photo but never in an intimate photo where only two of them are present, their intimacy level in the social event is rated relatively low, and A's intimate photos with other people will not be shared with C.

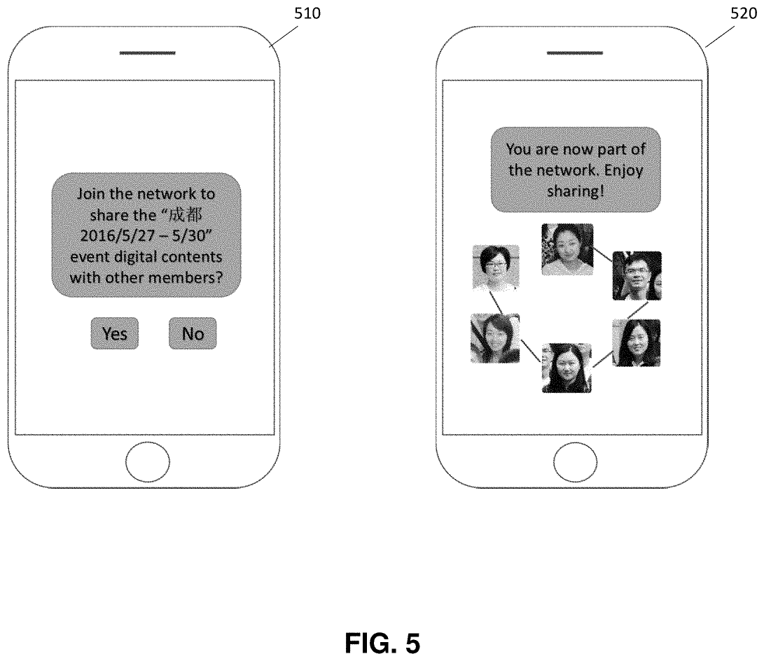

FIG. 5 depicts exemplary invitation and network screens of a trusted network according to embodiments of the invention. When a potential attendee is invited to join a trusted network, they may receive an invitation, such as displayed in screen 510. If the potential attendee elects to join the trusted network, they will enable other admitted attendees to access their photos of the event, and in turn, will be granted access to others' photos of the event. Once the potential attendee joins the trusted network, they may be greeted with an image of the attendees, such as shown in screen 520.

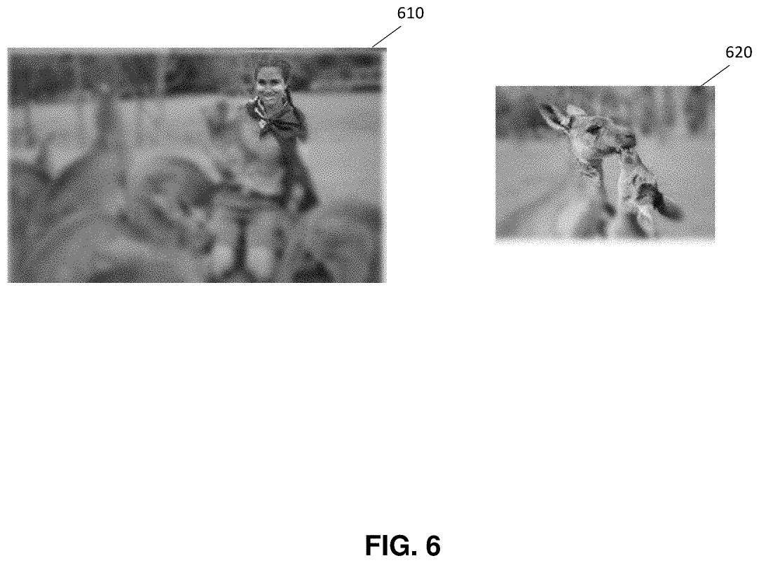

FIG. 6 depicts low-resolution photo previews from a trusted network according to embodiments of the invention. Preview photo 610, for example, shows that a key element of the photo, the person's face, is in a higher resolution than surrounding portions of photo 610. Similarly, preview photo 620 shows the higher resolution of the kangaroo's face as compared to remaining portions of the photo.

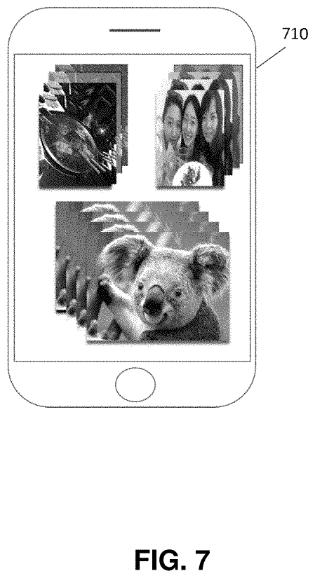

FIG. 7 depicts grouping low-resolution photo previews from a trusted network according to embodiments of the invention. Screen 710 illustrates preview photos being grouped together according to the subject matter of the photo. The hotpot preview photos in the upper left corner are grouped together, as are the group preview photos in the upper right corner and the koala bears in the lower portion of the screen 710. By grouping the photos together, it is easier for a requestor to select the best photo to retrieve.

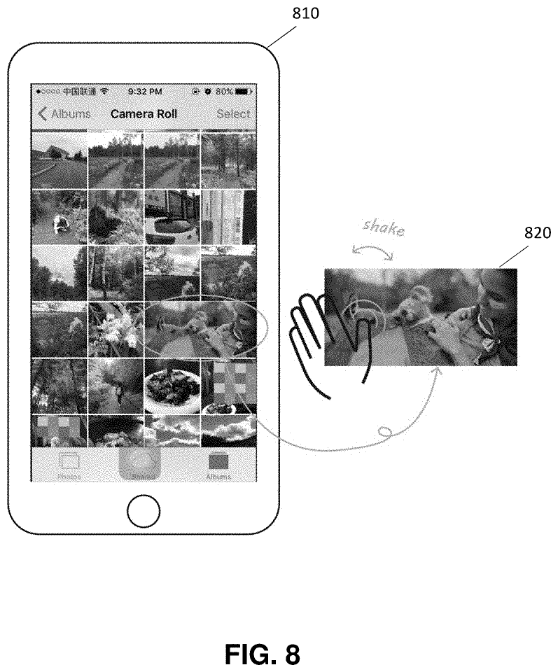

FIG. 8 depicts a screen and selection gesture to retrieve similar photos from a trusted network according to embodiments of the invention. Screen 810 illustrates a number of photos on a requestor's device. If a requestor selects a photo 820 and a portion of the photo, such as the kangaroo nuzzling the koala, using a gesture, such as a shake, the requestor may retrieve similar preview photos from the trusted network.

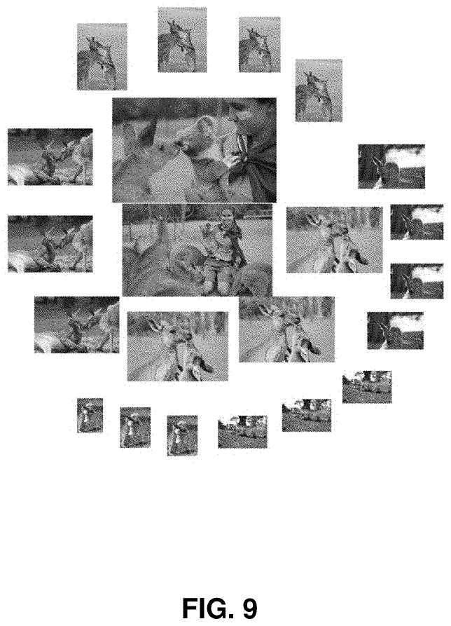

FIG. 9 depicts returned low-resolution photo previews from a trusted network according to embodiments of the invention. The returned preview photos are displayed according to their relevance to the input photo, as well as the element selected. Another dimension of time is used when the relevance is at the same level.

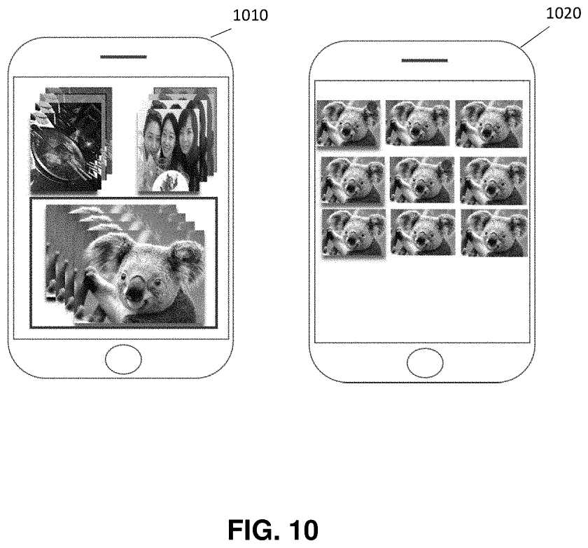

FIG. 10 depicts returned low-resolution photo previews following an extended gesture from a trusted network according to embodiments of the invention. The longer a requestor uses the gesture, such as a shake, the more preview photos that are returned.

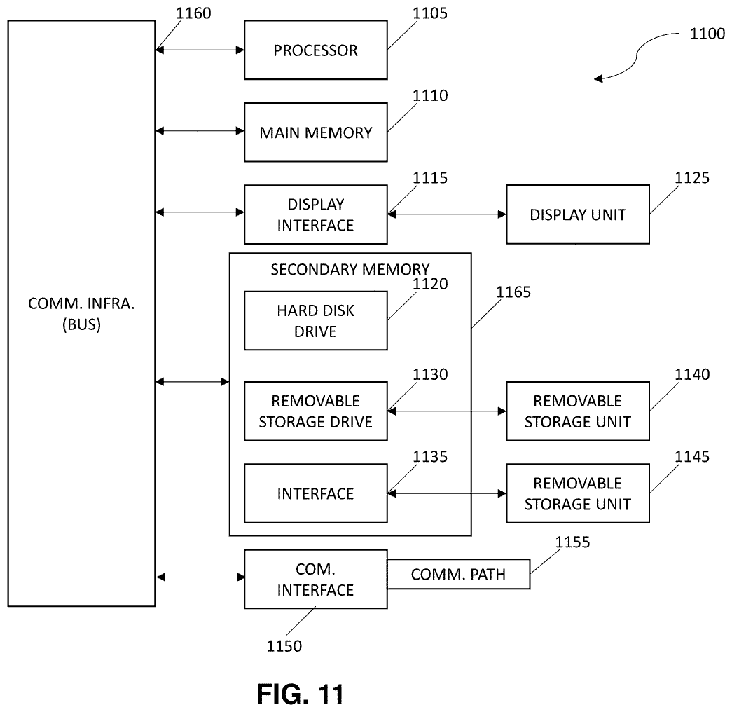

FIG. 11 depicts details of an exemplary computing system capable of implementing aspects of the invention. FIG. 11 depicts a high level block diagram computer system 1100, which can be used to implement one or more aspects of the present invention. More specifically, computer system 1100 can be used to implement some hardware components of embodiments of the present invention. Although one exemplary computer system 1100 is shown, computer system 1100 includes a communication path 1155, which connects computer system 1100 to additional systems (not depicted) and can include one or more wide area networks (WANs) and/or local area networks (LANs) such as the Internet, intranet(s), and/or wireless communication network(s). Computer system 1100 and additional system are in communication via communication path 1155, e.g., to communicate data between them.

Computer system 1100 includes one or more processors, such as processor 1105. Processor 1105 is connected to a communication infrastructure 1160 (e.g., a communications bus, cross-over bar, or network). Computer system 1100 can include a display interface 1115 that forwards graphics, text, and other data from communication infrastructure 1160 (or from a frame buffer not shown) for display on a display unit 1125. Computer system 1100 also includes a main memory 1110, preferably random access memory (RAM), and can also include a secondary memory 1165. Secondary memory 1165 can include, for example, a hard disk drive 1120 and/or a removable storage drive 1130, representing, for example, a floppy disk drive, a magnetic tape drive, or an optical disk drive. Removable storage drive 1130 reads from and/or writes to a removable storage unit 1140 in a manner well known to those having ordinary skill in the art. Removable storage unit 1140 represents, for example, a floppy disk, a compact disc, a magnetic tape, or an optical disk, etc. which is read by and written to by removable storage drive 1130. As will be appreciated, removable storage unit 1140 includes a computer readable medium having stored therein computer software and/ or data.

In alternative embodiments, secondary memory 1165 can include other similar means for allowing computer programs or other instructions to be loaded into the computer system. Such means can include, for example, a removable storage unit 1145 and an interface 1135. Examples of such means can include a program package and package interface (such as that found in video game devices), a removable memory chip (such as an EPROM, or PROM) and associated socket, and other removable storage units 1145 and interfaces 1135 which allow software and data to be transferred from the removable storage unit 1145 to computer system 1100.

Computer system 1100 can also include a communications interface 1150. Communications interface 1150 allows software and data to be transferred between the computer system and external devices. Examples of communications interface 1150 can include a modem, a network interface (such as an Ethernet card), a communications port, or a PCM-CIA slot and card, etcetera. Software and data transferred via communications interface 1150 are in the form of signals which can be, for example, electronic, electromagnetic, optical, or other signals capable of being received by communications interface 1150. These signals are provided to communications interface 1150 via communication path (i.e., channel) 1155. Communication path 1155 carries signals and can be implemented using wire or cable, fiber optics, a phone line, a cellular phone link, an RF link, and/or other communications channels.

In the present description, the terms “computer program medium,” “computer usable medium,” and “computer readable medium” are used to generally refer to media such as main memory 1110 and secondary memory 1165, removable storage drive 1130, and a hard disk installed in hard disk drive 1120. Computer programs (also called computer control logic) are stored in main memory 1110 and/or secondary memory 1165. Computer programs can also be received via communications interface 1150. Such computer programs, when run, enable the computer system to perform the features of the present invention as discussed herein. In particular, the computer programs, when run, enable processor 1105 to perform the features of the computer system. Accordingly, such computer programs represent controllers of the computer system.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instruction by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

1. A computer-implemented method comprising:
identifying, using a processor, an event and potential attendees at the event based on photo metadata and facial recognition;
establishing, using the processor, the event and attendees at the event;
receiving, using the processor, a selection serving as a filtering element within an existing photo of one of the potential attendees at the event who is a requestor;
sending, using the processor, a preview photo based on an original photo from another attendee at the event to the potential attendee who is the requestor ,wherein the preview photo is sent based on a resemblance of at least a portion of the original photo to the filtering element;
receiving, using the processor, a selection of the preview photo from the requestor; and
sending, using the processor, the original photo based on the preview photo to the requestor.

2. The computer-implemented method of claim 1, wherein identifying the event and potential attendees comprises identifying, by the processor, the event based on proximity of a first potential attendee to a second potential attendee.

3. The computer-implemented method of claim 2, wherein proximity is established based on time and place similarity between a first photo on a first potential attendee's device and a second photo on a second potential attendee's device.

4. The computer-implemented method of claim 2, wherein proximity is established based on a first transportation route of the first potential attendee and a second transportation route of the second potential attendee being similar.

5. The computer-implemented method of claim 2, wherein proximity is established based on the first potential attendee and the second potential attendee appearing in the same photograph.

6. The computer-implemented method of claim 1, wherein identifying the event and potential attendees comprises identifying, by the processor, the event based on a social connectivity and activity of a first potential attendee and a second potential attendee.

7. (canceled)

8. A system comprising:
a memory;
a processor communicatively coupled to the memory, the processor operable to execute instructions stored in the memory, the instructions causing the processor to:
identify an event and potential attendees at the event based on photo metadata and facial recognition;
establish the event and attendees at the event;
receive a selection serving as a filtering element within an existing photo of one of the potential attendees at the event who is a requestor;
send a preview photo based on an original photo from another attendee at the event to the potential attendee who is the requestor ,wherein the preview photo is sent based on a resemblance of at least a portion of the original photo to the filtering element;
receive a selection of the preview photo from the requestor; and
send the original photo based on the preview photo to the requestor.

9. The system of claim 8, wherein identifying the event and potential attendees comprises identifying the event based on proximity of a first potential attendee to a second potential attendee.

10. The system of claim 9, wherein proximity is established based on time and place similarity between a first photo on a first potential attendee's device and a second photo on a second potential attendee's device.

11. The system of claim 9, wherein proximity is established based on a first transportation route of the first potential attendee and a second transportation route of the second potential attendee being similar.

12. The system of claim 9, wherein proximity is established based on the first potential attendee and the second potential attendee appearing in the same photograph.

13. The system of claim 8, wherein identifying the event and potential attendees comprises identifying event based on a social connectivity and activity of a first potential attendee and a second potential attendee.

14. (canceled)

15. A computer program product for sharing photos, the computer program product comprising a computer readable storage medium having program instructions embodied therewith, the program instructions executable by a computer, to cause the computer to perform a method comprising:
identifying an event and potential attendees at the event based on photo metadata and facial recognition;
establishing the event and attendees at the event;
receiving a selection serving as a filtering element within an existing photo of one of the potential attendees at the event who is a requestor;
sending a preview photo based on an original photo from another attendee at the event to the potential attendee who is the requestor ,wherein the preview photo is sent based on a resemblance of at least a portion of the original photo to the filtering element;
receiving a selection of the preview photo from the requestor; and
sending the original photo based on the preview photo to the requestor.

16. The computer program product of claim 15, wherein identifying the event and potential attendees comprises identifying the event based on proximity of a first potential attendee to a second potential attendee.

17. The computer program product of claim 16, wherein proximity is established based on time and place similarity between a first photo on a first potential attendee's device and a second photo on a second potential attendee's device.

18. The computer program product of claim 16, wherein proximity is established based on a first transportation route of the first potential attendee and a second transportation route of the second potential attendee being similar.

19. The computer program product of claim 16, wherein proximity is established based on the first potential attendee and the second potential attendee appearing in the same photograph.

20. The computer program product of claim 15, wherein identifying the event and potential attendees comprises identifying the event based on a social connectivity and activity of a first potential attendee and a second potential attendee.
